(19) United States
(12) Patent Application Publication
(10) Pub. No.: US 2006/0017706 A1
(43) Pub. Date: Jan. 26, 2006

(54) Display for stylus input displays

(75) Inventors: David Cutherell, Austin, TX (US); Tom Bentley, Austin, TX (US)

Correspondence Address: FORTKORT GRETHER + KELTON LLP, 9442 N. Capital of Texas Hwy., Suite 500, AUSTIN, TX, 78759, US

(73) Assignee: Motion Computing, Inc.

(21) Appl. No.: 11/126,942

(22) Filed: May 11, 2005

Related U.S. Application Data
(60) Provisional application No. 60/569,818, filed on May 11, 2004.

(51) Int. Cl. G09G 5/00

(52) U.S. Cl. 345/173

(57) ABSTRACT

Improvements to computer displays particular displays for tablet PCs to: increase their clarity, contrast ratio and viewability in high ambient light conditions such as sunlight; cooler operation; and more rugged structure.

### CROSS-REFERENCE TO RELATED PATENT APPLICATIONS

This utility patent application claims priority on provisional patent application Ser. No. 60/569,818 filed on May 11, 2004.

### FIELD OF THE INVENTION

This invention relates to displays for computer systems. Particularly displays which can receive user input directly on the display.

### BACKGROUND OF THE INVENTION

Currently there are a number of manufacturers of computing devices that employ displays which are designed to receive input from the user. For example tablet personal computers available from Motion Computing, Inc. of Austin Tex. The prior art configuration of one of these displays is illustrated in FIG. 1. The display assembly 10 is comprised of an LCD 12, liquid crystal display, such as displays that are commercially available for many sources such as Toshibi, Sharp, NEC Boe Hydis or Hyundai Electronics in South Korea.

Underneath the LCD 12 is a digitizer 14. The digitizer works in combination with the LCD 12 and a Stylus (not shown) to receive and track input from a user. A suitable digitizer is available from Wacom. When receiving input from the user through the stylus, the LCD 12 requires a suitable writing surface for the stylus. In the prior art a faceplate 16 is used for this purpose. Typically this faceplate 16 is manufactured from transparent plastic such as acrylic.

In some prior art units the acrylic is precision cut so that it fits precisely into an opening in the case 20 of the tablet. The advantage of this is that by allowing the faceplate 16 to fit into the opening the overall thickness of the tablet housing can be kept thinner.

Typically but not necessarily the faceplate 16 is mounted to the LCD unit 12 by means of double sided tape 18. One side affixes to the LCD unit 12 and the other to the faceplate 16.

During operation, there is typically an air gap 22 between the LCD unit 12 and the faceplate 16. This gap 22 is not necessarily uniform in thickness across the display 10—particularly when used in combination with the stylus (not shown). The faceplate 16 keeps the LCD from pooling (accumulation of LCD liquid around the stylus when pressure is applied to the display from the stylus (not shown).

The outer surface 24 of the faceplate is textured to give a quality of resistance to movement of the stylus across the faceplate 16 that approximates resistance to which a human user is accustom when using a writing instrument on paper. This texture can by applied in a variety of ways. For example it can be formed directly in the surface of the faceplate 16 during manufacture of the material or after the material is manufactured. It can also be applied via a thin sheet of textured material affixed to the faceplate. Such films or laminates are commercially available from 3M. These prior art configurations cause disadvantages in the visibility of the display

FIG. 2 illustrates the mechanisms of some of these disadvantages. One of the disadvantages is the visibility of the display in high background lighting conditions such as outside in the sunlight. When sunlight 30 strikes the faceplate some of the light is reflected 32 by the surface 24 of the faceplate 16. The amount of this reflection is increased by the textured surface 24 of the faceplate 16. The balance of the light 34 is transmitted through the faceplate 16 but travels at a different angle due to the index of refraction of the material is different from the refraction of light through air. When the light 34 reaches the inner surface 26 of the faceplate, some of this light 36 is reflected 36 back up through the faceplate. The balance of the light 34 passes through the air gap 22 until it strikes the LCD 12 and is absorbed or reflected 40 back through the air gap 22 up to the faceplate 16. Each time light strikes a surface some of the light is reflected and some is transmitted. Each time the light is transmitted some of the light is transmitted based on the index of refraction of the material and some is absorbed and some scatters. This refracted and reflected light makes it much more difficult to see the output of the display in high ambient light such as sunlight.

FIG. 3 illustrates another optical disadvantage of the prior art displays for tablet PCs. The light 42 emitted by the LCD 12 travels up through the air gap 22 when it strikes the inner surface 26 some of the light is transmitted 44 and some is reflected 46. Similar results occur when the light strikes the outer surface 24 of the faceplate 16. These refractions and reflections cause ghost images that decrease the clarity of the image and decrease the contrast ratio of the display output.

FIG. 2 and FIG. 3 illustrate two mechanisms by which the prior art faceplate decreases the viewability of the display. It should be appreciated that the figures only illustrate one incident ray of light each at one incident angel or one viewing angle respectively. It should be further appreciated that increase angle of incidence or a wider viewing angle may results in even worse performance of the display's viewability

These disadvantages are addressed by improvement to the design of the displays for tablet PCs as described below.

### BRIEF DESCRIPTION OF THE DRAWINGS

For a more complete understanding of the present invention, and the advantages thereof, reference is now made to the following brief descriptions taken in conjunction with the accompanying drawings, in which like reference numerals indicate like features:

FIG. 1 is an illustration of the configuration of components of a prior art display for a tablet PC;

FIG. 2 is an illustration of mechanisms that cause prior art displays to be difficult to view in sunlight;

FIG. 3 is an illustration of mechanisms that decrease the clarity and contrast ratio of prior art tablet PC displays due to internal reflections;

FIG. 4 is an illustration of an improved display for a tablet PC;

FIG. 5 is an illustration showing greater detail of the outer functional surfaces of an embodiment of an improved display/input device for tablet PCs;

FIG. 6 is an illustration of an alternative bezel configuration that allows for an overall thinner device

FIG. 7 is an illustration of an in-frame mounting configuration

FIG. 8 is an illustration of an over-frame mounting configuration

### DETAILED DESCRIPTION OF THE INVENTION

The invention provides improvements to displays for tablet PCs. The advantages and benefits of the improvements will become more apparent from the remainder of the detailed description when taken in conjunction with the accompanying drawings. The following examples further illustrate the invention but, of course, should not be construed as in any way limiting its scope. The improvements apply to displays generally but particularly to displays which receive input directly from the user by means of mechanisms such as a stylus such as displays for tablet PCs.

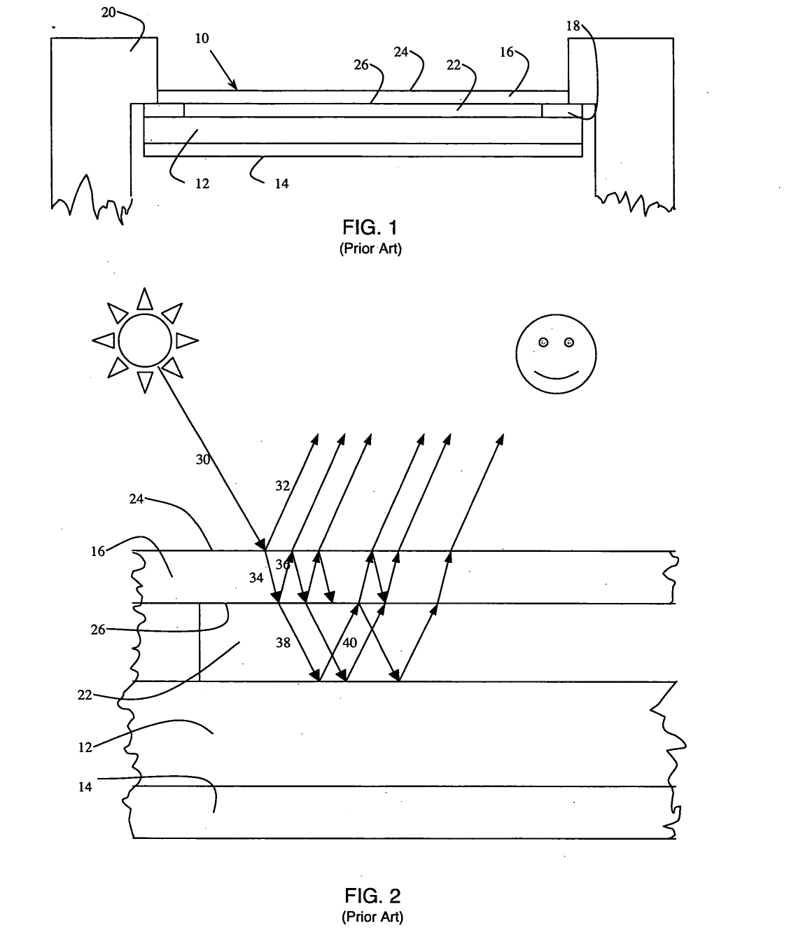

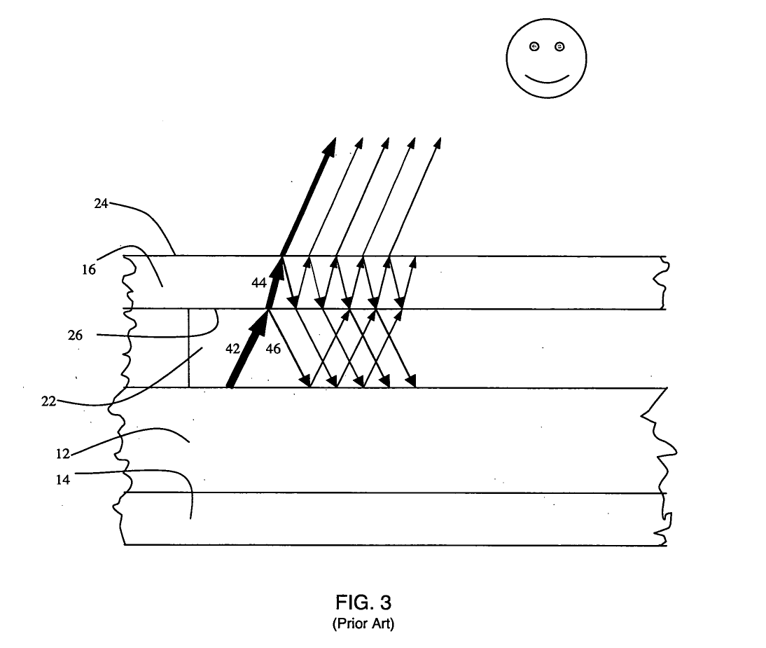

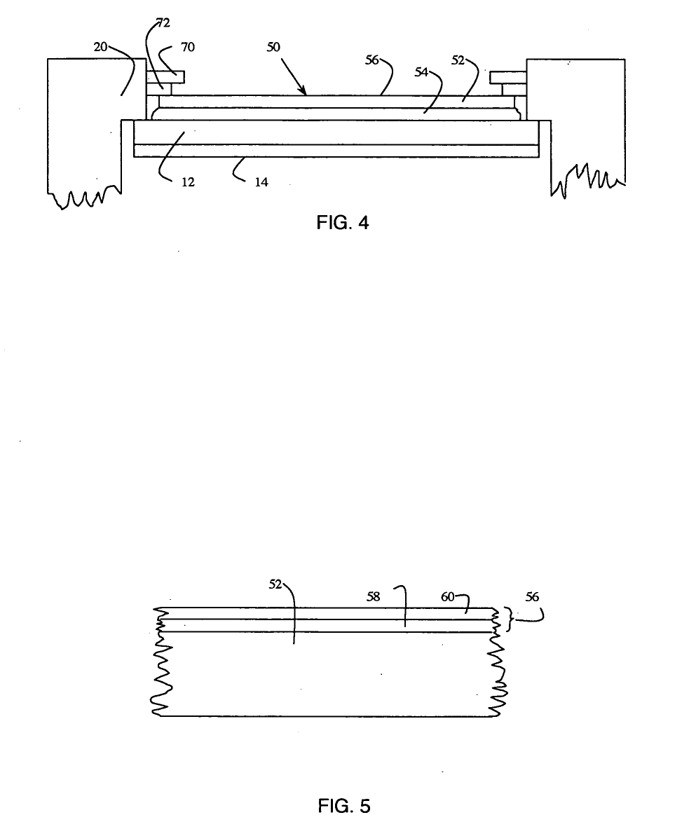

FIG. 4 is an illustration of an improved display 50. Like with the prior art display/input device 10 described in FIG. 1, the improved display/input device 50 have a LCD unit 12 and digitizer 14 and the display is mounted in a housing 20. The improvements are to the writing interface mechanism for the display. The writing surface is a combination of a thin glass sheet 52 combined with bonding adhesive 54 with a matching index of light refraction. A suitable bonding adhesive would be readily available optical grade epoxies or silicon adhesives.

A suitable glass covering for the bonding adhesive would be sodalime glass about 1.1 mm thick. Other materials would also be suitable and may be preferable for some applications. It is preferable that the covering material and the adhesive bond have similar indexes of refraction of light. In the preferred embodiment illustrated in FIG. 4 and FIG. 5, glass was used.

In alternative embodiments the a second or alternative digitizer could take the place of the protective cover 52—for example a touch screen type digitizer. With these embodiments it would be possible to input data through a stylus were the input would be received/recognized by the digitizer 14 below the LCD display 12 or by stylus or touch which would be received by the digitizer 52 mounted on top of the LCD display 12.

FIG. 5 illustrated in greater detail the glass covering of FIG. 4. The outer surface 56 glass covering has thin film coatings 58 & 60 applied to serve two different functions. One function is to serve as an interference filter that acts as an antireflective coating like those applied to prevent the reflective glare off of eye-glasses. Suitable interference filters for this purpose typically include combinations of layers of materials with high and low indexes of refraction of light. For example layers or Titanium Dioxide provide a high index of refraction and layers of Silicon Dioxide provide a low index of refraction. In combination these layers act as interference filters. Interference filters are characterized by their spectral performance in light reflection and transmission. In other words the light that is transmitted through the filter is dependant on the frequency of the light. Likewise, the reflectance of the filter is dependant on the frequency of the light.

In the art of interference filters it is well know how to construct a filter that has desired spectral (frequency transmission and reflectance) characteristics. In addition or substitution to Titanium Dioxide and Silicon Dioxide, many materials would be suitable for constructing suitable interference filters.

Some embodiments of the present invention employing interference filters that are optimized to allow the transmission of the frequencies of light generated by the LCD 12. Typically monitors generate color using three primary colors such as Red Green and Blue (RGB). In another embodiment the filter is optimized to maximize the frequency of light based on the sensitivity characteristics of the human eye. The human eye is responsive to frequencies roughly between 400 to 700 nm. The cones which provide daylight and color vision are generally optimized for one of three colors: Blue (about 440 nm) and Green (about 535 nm) and Orange (about 565 nm). The use of such specially designed interference filters can maximize the perceived brightness of the display particularly in sunlight.

In other embodiments, rather than using interference filters a broad band antireflective coating could serve to reduce reflective glare. One example of a suitable broadband antireflective coating is Magnesium Fluoride. In yet other embodiments the interference filter referenced above can be topped with broadband antireflective coating such as Magnesium Fluoride.

In the embodiment illustrated in FIG. 5, the antireflective or interference/antireflection function layer(s) 58 lies beneath another functional layer 60. This layer 60 provides an anti-smudge function. In some embodiments, the anti-smudge layer 60 is a hydrophobic coating applied as the top layer facing the outside of the display 10. One example of a hydrophobic layer is uses polysiloxanes which are comprised of silicon bonded to ethyl or methyl groups and bonded to each other through an oxygen bond. The Silicon and Oxygen bonds give the material a Silicon Dioxide glass like hardness and the ethyl/methyl groups give the material its hydrophobicity. These materials can be applied in a plasma vacuum deposition process. In the process oxygen can be introduced in higher concentrations at first to make a harder under layer because it will generate more silicon oxygen bonds making the layer harder like silicon dioxide. Then the oxygen levels can be brought down leaving more silicon ethyl/methyl bonds resulting in greater hydrophobicity. To increase the hydrophobicity Flourene gas or gasses of compounds containing Flouron can be introduced which will increase the contact angle of water (hydrophobicity) on the surface of the layer.

Although it is not illustrated in the figures, another feature of the present invention is the texture of the outer surface of the display unit 50. The purpose of the textured surface is to provide resistance to the movement of a stylus (not shown) which works in conjunction with the LCD 12 and digitizer 14 for the display unit 50 to serve as a input and output device. The purpose of the resistance is to, as closely as possible, approximate the feel of writing on paper. Too much or too little resistance makes it harder to use the display as an input device.

One method of obtaining the texture is to blank etch the outer surface of the protective glass 52 or one of the layers 58, 60 on top of the protective glass. More uniform results can be obtained by applying a photoresist mask on the surface and etching a pattern on the surface rather than a blank etch. Other methods of texturing the glass or other layers described above are also possible. In the alternative one of the other layers 58, can be textured by similar methods. In other embodiments the top surface is textured by laying one of the layers 58, 60 irregularly. One method of accomplishing this result is introducing a screen in the vacuum deposition process so that they layers are not uniformly applied across the surface of the protective glass 12.

Interference and hydrophobic coatings are readily available for optical suppliers from companies like OCLI in California and other similar suppliers of optical components. When these coatings are selected the degree of hardness, hydrophobicity and spectral response of the resultant product can be specified. Additionally, when these coatings are applied, the surface treatment can be specified. In alternative embodiments other materials could be used to provide these functions. In the preferred embodiment the glass is etched for texture prior to the application of the thin film coatings. However in other embodiments the partial surface etching can be applied after the coatings are applied or between coatings. In yet other embodiments the texture can result from the coating process.

Returning to FIG. 4, another feature of the improved display relates to assembly of the components. As described with the prior art it is desirable to keep the overall thickness of the assembly. In the case of the acrylic protective sheet it is precision cut to fit into the opening in the tablet PC housing 20.

It is much more difficult to cut an amorphous material like glass with matching precision. Additionally when assembling the adhesive and glass protective layer, there may be overflow of adhesive from the sides. FIG. 4 illustrates an assembly employing a protective mounting bezel 70. In this embodiment shown the bezel 70 drops into the opening in the tablet housing 20 and is affixed to the surface of the glass by double sided adhesive tape 72. This bezel provides the dual functionality of protecting the edge of the glass and limiting the overall thickness of the assembly.

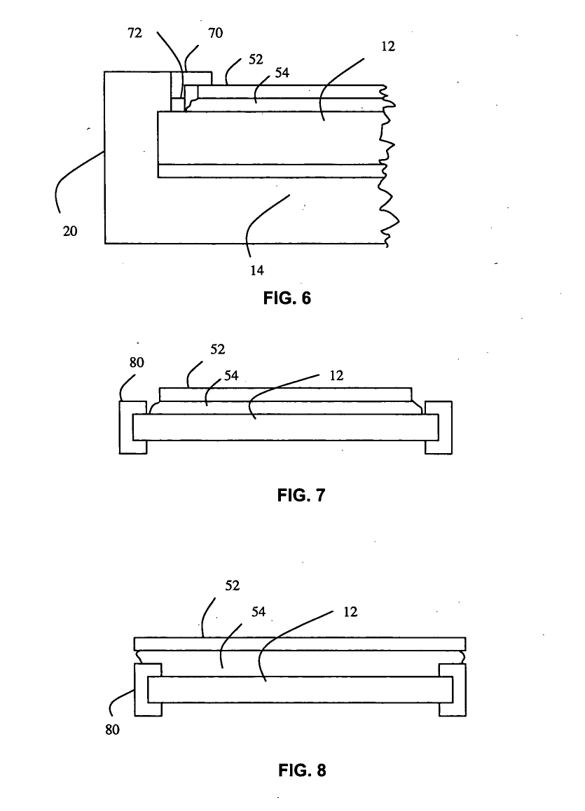

FIG. 6 illustrates a different protective bezel 70 configuration. In this configuration the bezel is mounted via double sided tape 72 to the LCD panel 12 and has a lip with a bottom surface 74 that rests on the top surface 56 of the faceplate 52 and a top surface which is approximately, flush with the tablet casing 20. This configuration allows for an even thinner overall design.

The light out of the display is now less encumbered by surface effects. This results from a design that employs layers with matching indexes of refractions and boundaries between materials are bonded and therefore continuous. Similarly effect of ambient light is reduced by the antireflective coatings and the limited internal reflectance of light transmitted into the display.

FIG. 7 and FIG. 8 illustrate two different configurations for mounting the protective cover 52 onto the display FIG. 7 illustrates an in-frame configuration where the protective cover 52 is mounted inside the LCD frame 80. This configuration allows for an overall thinner device. FIG. 8 illustrates an over-fram configuration where the protective cover is mounted over the tope of the LCD frame 80 this configuration maximizes the usable space on the LCD.

An additional benefit of the improved display is it thermal energy transmission properties. The previous display acts like storm window with a layer of air sandwiched between two pains of glass. The improved display is a solid block which more readily transmits heat. Since cooling is frequently and issue that must be taken into consideration by designers this is a particularly beneficial feature of the improved display. Since the display is always outward facing and usually upward facing, it is in a better position to radiate and cause a convective airflow up and away from the unit. The improved display also serves to cool the unit.

Since the display is brighter it can be operated at lower intensities than prior art displays thus using less energy. This energy efficiency plus the energy efficiency from operating at cooler temperatures enables the additional benefit of improved battery life of the.

Another advantage of the improved display is that it is more rugged than the prior art displays. In the embodiment illustrated the composite LCD epoxy and glass structure is much more resistant to torque making the unit more rugged.

What is claimed is:

1. A computer system with a combined output and input display comprising:
a computer system which generates a video output signal;
a display which converts the video output signal into a visual for perceptible by a human user;
a digitizer mounted adjacent to the display which detects the user input in relation to the display output and converts the input into a signal processable by the computer system; and
a protective sheet affixed to the display adhesively so that there is no air gap between the protective sheet and the display.

2. The computer system with input/output display of claim 1 wherein the protective sheet has an antireflective coating

3. The computer system with input/output display of claim 1 wherein the protective sheet has an interference coating

4. The computer system with input/output display of claim 3 wherein the interference coating is optimized for the primary colors generated by said display.

5. The computer system with input/output display of claim 3 wherein the interference coating is optimized for the primary colors detectible by the cones in the retna of the human eye.

6. The computer system with input/output display of claim 1 wherein the protective sheet has a hydrophobic coating

7. The computer system with input/output display of claim 6 wherein the protective sheet is textured to provide resistance for stylus input.

8. The computer system with input/output display of claim 1 wherein the protective sheet has an antireflective coating and a an anit-smudge coating.

9. The computer system with input/output display of claim 8 wherein the protective sheet is textured to provide resistance for stylus input.

10. The computer system with input/output display of claim 1 wherein the protective sheet has a coating that provides broadband light transmission properties and high hydrophobicity properties.

11. The computer system with input/output display of claim 10 wherein the protective sheet is textured to provide resistance for stylus input.

12. A combined input and output display input/output display comprising:
a computer system which generates a video output signal;
a display which converts the video output signal into a visual for perceptible by a human user wherein the display as a continuous set of functional protective layers with no air gaps between the layers;
a digitizer mounted adjacent to the display which detects the user input in relation to the display output and converts the input into a signal processable by the computer system; and
a protective sheet affixed to the display adhesively so that there is no air gap between the protective sheet and the display.

13. The input/output display of claim 12 wherein the functional layers include a hydrophobicity layer.

14. The input/output display of claim 12 wherein the functional layers include an antireflective layer.

15. The input/output display of claim 12 wherein the functional layers include a hydrophobicity and antireflective layer.

16. The input/output display of claim 12 wherein the outer surface is textured to provide resistance for stylus input.

17. A combined input and output display input/output display comprising:
a computer system which generates a video output signal;
a display which converts the video output signal into a visual for perceptible by a human user wherein the display as a continuous set of functional protective layers including a combined antireflective anti-smudge layer with no air gaps between the layers;
a digitizer mounted adjacent to the display which detects the user input in relation to the display output and converts the input into a signal processable by the computer system; and
a protective sheet affixed to the display adhesively so that there is no air gap between the protective sheet and the display.

18. A combined input and output display input/output display of claim 17 wherein the protective layers are mounted to the display with an index of refraction matching adhesive layer.

19. A combined input and output display input/output display of claim 17 wherein a protective bezel is mounted on top of the outer edges of the protective layers.
